(19) United States
(12) Patent Application Publication
(10) Pub. No.: US 2011/0178642 A1
(43) Pub. Date: Jul. 21, 2011

(54) INFORMATION PROCESSING APPARATUS

(75) Inventor: Katsunori FUJII, Kawasaki (JP)

(73) Assignee: FUJITSU LIMITED, Kawasaki-shi (JP)

(21) Appl. No.: 13/004,616

(22) Filed: Jan. 11, 2011

(30) Foreign Application Priority Data
Jan. 21, 2010 (JP) 2010-10927

(51) Int. Cl. G06F 19/00; G05D 23/00; G06F 1/32; G01F 1/00

(52) U.S. Cl. 700/276; 713/323; 702/45

(57) ABSTRACT

An information processing apparatus having a fan that releases air from the inside of a housing includes, a first passage through which air flows from the fan to a first air outlet, a second passage branched from the mid-flow of the first passage and communicating with a second air outlet, an air amount meter arranged on the second passage, which measures the amount of air flow from the first passage to the second passage, and a determining unit that determines whether the first air outlet is covered based on the amount of air measured by air the amount meter.

### CROSS-REFERENCE TO RELATED APPLICATIONS

This application is based upon and claims the benefit of priority of the prior Japanese Patent Application No. 2010-10927, filed on Jan. 21, 2010, the entire contents of which are incorporated herein by reference.

### BACKGROUND

Information processing apparatuses, such as personal computers or servers, increase their internal temperatures due to heat generated from their electronic structural components. An increase in temperature in the information processing apparatus may cause malfunction and failure. To prevent the information processing apparatus from causing malfunction and failure, there is a need of cooling the inside of the information processing apparatus.

In order to let the information processing apparatus cool, for example, the cooling of the information processing apparatus has been performed using a process for exhausting air of increased temperature by controlling the number of rotations of a fan arranged in the inside of the information processing apparatus and the temperature (inner temperature) thereof (for example, Japanese Unexamined Patent Application Publication No. 2001-185884).

### SUMMARY

According to an aspect of the invention, an information processing apparatus having a fan that releases air from the inside of a housing includes, a first passage through which air flows from the fan to a first air outlet, a second passage branched from the mid-flow of the first passage and communicating with a second air outlet, an air amount meter arranged on the second passage, which measures the amount of air flow from the first passage to the second passage, and a determining unit that determines whether the first air outlet is covered based on the amount of air measured by air amount meter.

The object and advantages of the invention will be realized and attained by the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration and function of an information processing apparatus according to a first embodiment;

FIG. 2 is a diagram illustrating an example hardware configuration of an information processing apparatus according to a second embodiment;

FIG. 3 is a diagram illustrating an example mechanism of exhausting air from the information processing apparatus according the second embodiment;

FIG. 4 is a block diagram illustrating the functions of the information processing apparatus according to the second embodiment;

FIG. 5 is a flow chart illustrating a process for determining whether covering of an air opening is performed in the information processing apparatus according to the second embodiment;

FIG. 6 is a diagram illustrating the state when the air opening of the information processing apparatus of FIG. 3 is being covered;

FIG. 7 is a diagram illustrating an example of a warning message which is displayed when the air opening is being covered;

FIG. 8 is a diagram illustrating a modified example of the second embodiment;

FIG. 9 is a diagram illustrating the state when the air opening of the information processing apparatus of FIG. 8 is being covered;

FIG. 10 is a diagram illustrating an example hardware configuration of an information processing apparatus according to a third embodiment;

FIG. 11 is a diagram illustrating an example mechanism of exhausting air from the information processing apparatus according the third embodiment;

FIG. 12 is a block diagram illustrating the functions of the information processing apparatus according to the third embodiment;

FIG. 13 is a flow chart illustrating a process for determining whether covering of an air opening is performed in the information processing apparatus according to the third embodiment;

FIG. 14 is a table illustrating the relation between the amounts of air flow of the respective air ventilation passages of the information processing apparatus according to the third embodiment;

FIG. 15 is a diagram illustrating the state when the air opening of the information processing apparatus of FIG. 11 is being covered;

FIG. 16 is a diagram illustrating a modified example of the third embodiment; and

FIG. 17 is a diagram illustrating the state when the air opening of the information processing apparatus of FIG. 16 is being covered.

### DESCRIPTION OF EMBODIMENTS

Hereinafter, embodiments of the present invention will be described with reference to the accompanying drawings.

### First Embodiment

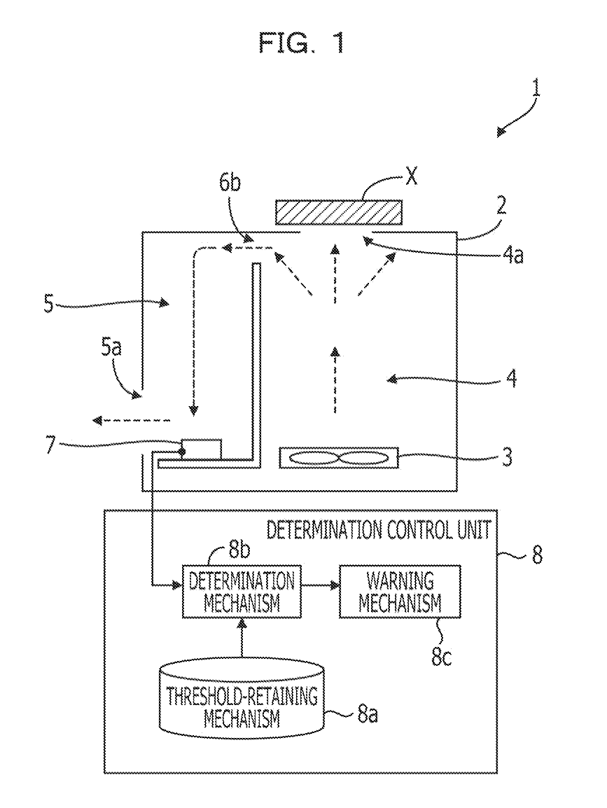

FIG. 1 is the configuration and function of an information processing apparatus according to a first embodiment.

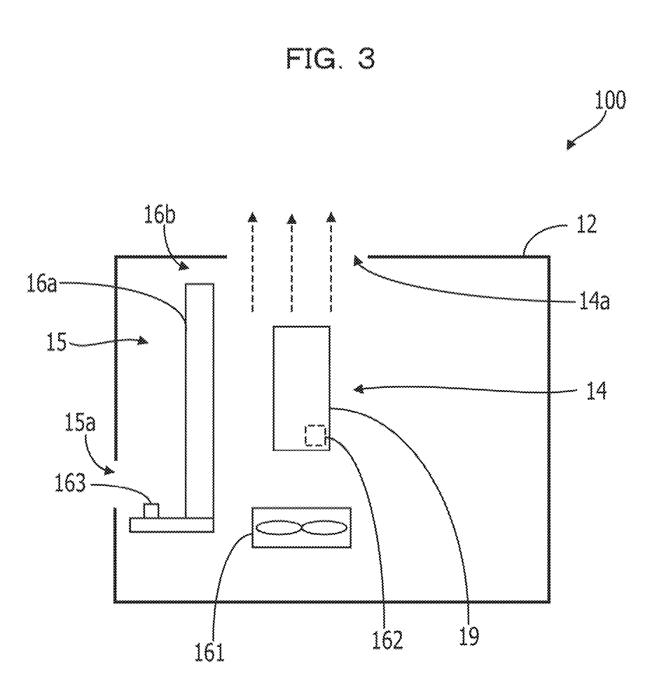

In FIG. 1, dashed arrows represent the flow of air from a blower module 3 in the information processing apparatus 1 to exhaust air. In addition to FIG. 1, dashed arrows represent the flow of air in FIGS. 3, 6, 8, 9, 11, and 15 to 17, which will be described later.

A blower module 3 is mounted in the housing 2 of the information processing apparatus 1 to exhaust air of increased temperature due to heat generation in the housing 2. Examples of the blower module 3 include a fan, a blower, and an air circulator.

In addition, two air outlets 4a and 5a are formed in the external surface of the housing 2. For example, in FIG. 1, these air outlets 4a and 5a are formed on the different sides of the housing 2, respectively. In the inside of the housing 2, an air release passage 4 through which air flowing from the blower module 3 into the air outlet 4a and an air release passage 5 which is branched from the mid-flow of the air release passage 4 and communicates with the air outlet 5a.

In the state where the air outlet 4a is not covered, most of the air flowing from the blower module 3 into the air release passage 4 is exhausted from the air outlet 4a. On the other hand, if the air outlet 4a is being covered by a covering member X, the air from the blower module 3 flows from the air release passage 4 into the air release passage 5 and is then exhausted from the air outlet 5a.

In addition, an air amount meter 7 is arranged in the air release passage 5. The air amount sensor 7 measures the amount of air flowing into the air release passage 5. It is noted that the arrangement positions of the respective air outlets 4a and 5a are not restricted to those shown in FIG. 1. In other words, the air outlet 5a may be arranged at an arbitrary position on the external surface of the housing 2 depending on the shape and arrangement position of the air release passage 5 which is branched from the mid-flow of the air release passage 4.

Furthermore, the information processing apparatus 1 includes a threshold-retaining mechanism 8a and a determination mechanism 8b. In addition, the information processing apparatus 1 may further include a warning mechanism 8c. The threshold-retaining mechanism 8a holds information about the threshold amount of air in advance. The threshold amount of the air is provided for comparison with the amount of air actually measured by the air amount sensor 7. The threshold amount of air is defined in order to allow the user to determine that the air outlet 4a is not covered when it is actually not covered. Thus, the measured amount of air allows the user to determine whether the air outlet 4a is being covered on the basis of the threshold amount of air.

The determination mechanism 8b makes comparison between the amount of air measured by the air amount sensor 7 and the threshold retained by the threshold-retaining mechanism 8a. If the amount of air measured is higher than the threshold, it is determined that the air outlet 4a is being covered. As a result, the state of the covering member X can be recognized.

If the determination mechanism 8b determines that the air outlet 4a is being covered, for example, the warning mechanism 8c sounds alarm or displays a warning message on a display device to warn the user of the fact that the air outlet 4a is being covered.

Furthermore, for example, the information processing apparatus 1 can be realized as a computer in which structural components (not shown in the figure), such as a central processing unit (CPU), a random access memory (RAM), and a hard disk drive (HDD), are connected to one another through a bus. In this case, for example, the function of the determination mechanism 8b can be realized as a circuit on a printed circuit board on which the CPU is mounted. Alternatively, the function of the determination mechanism 8b may be realized by executing a predetermined program by the CPU.

Next, description will be made on an example of a process for determining whether the air outlet 4a of the information processing apparatus 1 having such configuration and functions is being covered, for example. First, for example, if the air outlet 4a is not covered, then the blower module 3 starts the flow of air when the temperature of the air release passage 4 in the information processing apparatus 1 becomes higher than a predetermined temperature. The air flow from the blower module 3 brings the heated air out of the air outlet 4a through the air release passage 4, causing a decrease in inner temperature of the information processing apparatus 1. If the temperature decreases lower than a predetermined temperature, then the blower module 3 may stop the flow of air.

In this case, when the blower module 3 causes the flow of air, part of air from the blower module 3 may be branched from the air release passage 4 and then flow into the air release passage 5 through a branching opening 6b. The amount of air flowing into the air release passage 5 is measured by the air amount sensor 7. Then, the determination mechanism 8b makes comparison between the amount of air measured and the threshold amount of air held by the threshold-retaining mechanism 8a. Since the comparison results in the fact that the amount of air measured is lower than the threshold, the determination mechanism 8b determines that the air outlet 4a is not covered.

Next, the case where the air outlet 4a is covered with the covering member X will be described. Like the above, if the inner temperature of the information processing apparatus 1 exceeds the predetermined temperature, the blower module 3 starts the flow of air. The air flow from the blower module 3 brings the heated air into the air release passage 4. However, a sufficient amount of the air is not exhausted from the air outlet 4a because the air outlet 4a is being covered by the covering member X. As shown in FIG. 1, much of air prevented from being exhausted from the air outlet 4a is branched from the branching opening 6a and then flows into the air release passage 5, followed by being exhausted from the air outlet 5a. Simultaneously, the air amount sensor 7 measures the amount of air flowing into the air release passage 5 by the air amount sensor 7. The determination mechanism 8b makes comparison between the amount of air measured and the threshold amount of air held by the threshold-retaining mechanism 8a. If the comparison results in the fact that the amount of air measured becomes higher than the threshold, the determination mechanism 8b determines that the air outlet 4a is not covered.

Furthermore, if the information processing apparatus 1 detects the covering member X, then the warning mechanism 8c warns the user of the fact that the air outlet 4a is being covered. For example, the warning mechanism 8c may warn the user by displaying a warning message, which notifies the user of the fact that the air outlet 4a is being covered, on a display device (not shown) connected to the information processing apparatus 1. Alternatively, the warning mechanism 8c may warn the user that air outlet 4a is covered by sounding alarm or by both the display and the sounding of the alarm. In this way, the user is warned that the air outlet 4a is being covered. Thus, the user may be urged to confirm the state of the air outlet 4a before an increase in inner temperature of the information processing apparatus 1 occurs.

As described above, the information processing apparatus 1 includes the air release passage 5 and the air flow sensor 7. The air release passage 5 is branched from the mid-flow of the air release passage 4 into which air from the blower module 3 flows and communicates with the air outlet 5a. The air flow sensor 7 is arranged on the air release passage 5. Furthermore, the information processing apparatus 1 is designed to determine whether the air outlet 4a is being covered depending on the amount of air measured by the air amount sensor 7.

Therefore, before a significant increase in inner temperature of the information processing apparatus 1, the air outlet 4a being covered by the covering member X can be detected. Thus, the information processing apparatus 1 may be prevented from causing malfunction and failure.

### Second Embodiment

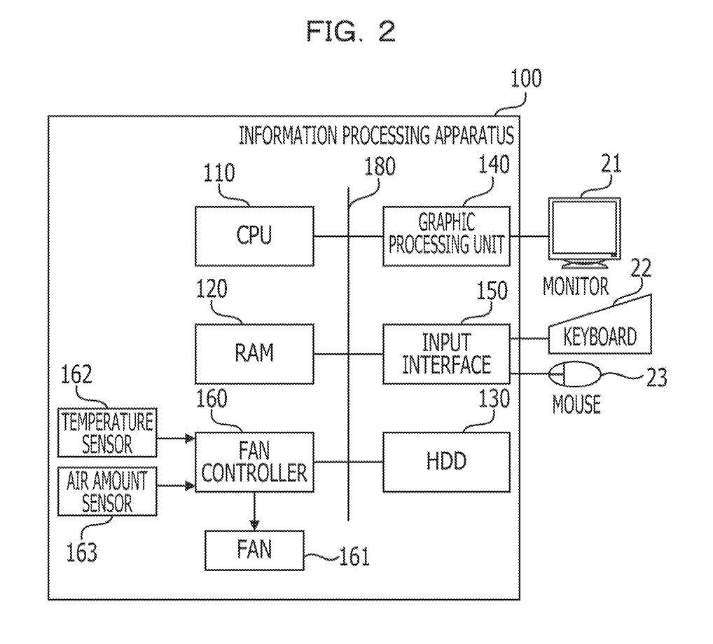

Next, in this embodiment, a computer will be described as an example of an information processing apparatus. FIG. 2 is a diagram that illustrates an example hardware configuration of the information processing apparatus according to the second embodiment. In addition, FIG. 3 is a diagram illustrating an example mechanism of exhausting air from the information processing apparatus according the second embodiment.

For instance, the information processing apparatus 100 is realized as a computer as shown in FIG. 2. The computer includes a CPU 110, a RAM 120, a HDD 130, a graphic processing unit 140, an input interface 150, and a fan controller 160. These structural components are connected to one another through a bus 180 and arranged in a housing 12 as shown in FIG. 3. In addition, both a temperature sensor 162 and an air amount sensor 163 are connected to the fan controller 160 and arranged at their predetermined positions in the housing 12 as shown in FIG. 3, respectively.

The CPU 110 executes various programs stored in a storage device medium, such as the HDD 130, to control the whole computer uniformly. The RAM 120 temporarily stores at least part of a program to be executed by the CPU 110 and various data required for processing such a program.

The HDD 130 stores programs to be executed by the CPU 110 and various data and so on required for execution of these programs. The graphic processing unit 140 is connected to a display device, such as a monitor 21. The graphic processing unit 140 displays an image on the screen of the monitor 21 in response to a command from the CPU 110.

The input interface 150 is connected to a keyboard 22 and a mouse 23, or the like. The input interface 150 sends signals from the keyboard 22 and the mouse 23 to the CPU 110 through the bus 180, respectively.

The fan controller 160 is connected to a fan 161 that exhausts air from the inside of the housing 12, a temperature sensor 162 that measures the inner temperature of the housing 12, and an air flow sensor 163 that measures the amount of air flowing into an air ventilation passage 15 (see FIG. 3, which will be described later) and flowing out therefrom.

Furthermore, as shown in FIG. 3, air outlets 14a and 15a are formed on the different sides of the housing 12, respectively. In the housing 12, an air ventilation passage 14 is arranged for exhausting the air introduced by the fan 161 from the air opening 14a. A fin 19 is arranged on the air ventilation passage 14 so that it may touch the cooling target. In addition, the air ventilation passage 15 is branched from the branching opening 16b in the mid-flow of the air ventilation passage 14 and communicates with the air opening 15a. The air ventilation passage 14 and the air ventilation passage 15 divided by a partition 16a and the branching opening 16b is located at the end of the partition 16a.

In addition, the locations of the air openings 14a and 15a are not limited to those illustrated in FIG. 3. In other words, the air opening 15a may be formed in an arbitrary position on the external surface of the housing 12 depending on the shape and location of the air ventilation passage 15 branched from the mid-flow of the air ventilation passage 14.

The fin 19 is made of a metallic material with high thermal conductivity, such as copper or aluminum, for example. In addition, the back of the fin 19 touches a target (not shown) that generates a large amount of heat, such as the CPU 110, and allows the target to enhance the heat release therefrom. Thus, the cooling of the target can be facilitated. Furthermore, the fin 19 is cooled by the flow of air from the fan 161 and flowing into the air ventilation passage 14. As a result, cooling capability may be further enhanced.

As shown in FIG. 3, a temperature sensor 162 is arranged in abutting contact with or in proximity to the target, such as the CPU 110, touching the fin 19 and measures the temperature of the target. For example, every time the temperature sensor 162 measures the temperature of the target sends a signal corresponding to the temperature to the fan controller 160.

The air amount sensor 163 is arranged near the air opening 15a in the air ventilation passage 15. In addition, the air amount sensor 163 may measure the amount of air per minute (liter per minute), for example, in one direction (from the branching opening 16b to the air opening 15a) along which air flows through the air ventilation passage 15. Then, the air amount sensor 163 sends an output signal which increases in proportion to an increase in amount of air measured to the fan controller 160.

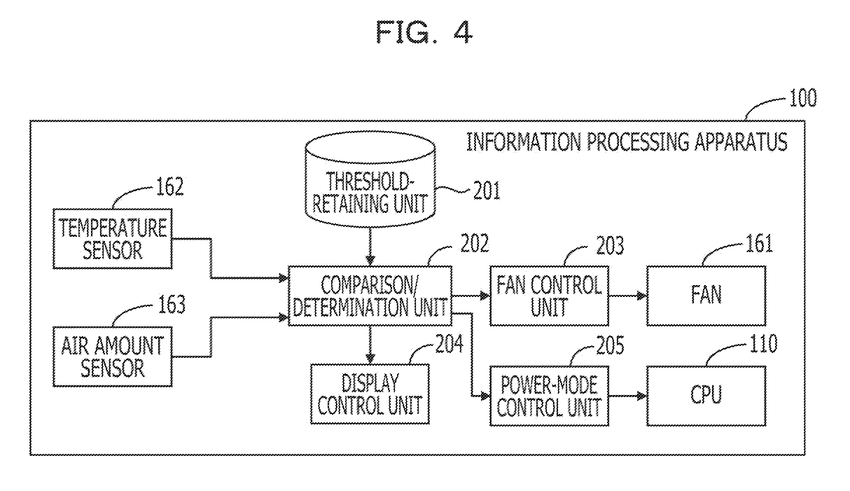

Next, the control function of the information processing apparatus 100 will be described. FIG. 4 is a block diagram illustrating the functions of the information processing apparatus according to the second embodiment. The information processing apparatus 100 determines whether the air opening 14a is being covered and executes predetermined processing depending on the result of the determination. To execute such processing, the information processing apparatus 100 includes a threshold-retaining unit 201, a comparison/determination unit 202, a fan control unit 203, a display control unit 204, and a power mode control unit 205.

The threshold-retaining unit 201 retains information about a predetermined threshold inner temperature of the information processing apparatus 100 and a predetermined threshold amount of air flown into the air ventilation passage 15 and exhausted from the air opening 15a. The number of rotations of the fan 161 may be controlled depending on the result of the comparison between the threshold temperature and the measured temperature. Depending on the result of the comparison between the threshold temperature and the measured temperature, it is determined whether the air opening 14a is being covered.

The comparison/determination unit 202 makes comparison between the temperatures measured by the temperature sensor 162 and the threshold temperature retained by the threshold-retaining unit 201.

Then, the comparison/determination unit 202 performs the subsequent processing depending on the result of the comparison. If the measured temperature is higher than the threshold, then the fan 161 starts rotating. In contrast, if the measured temperature is lower than the threshold, then the comparison/determination unit 202 sends a control request to the fan control unit 203 so that the fan 161 may stop rotating.

In addition, the comparison/determination unit 202 makes comparison between the amount of air measured transmitted from the air amount sensor 163 and the threshold amount of air retained by the threshold retaining unit 201. Then, the comparison/determination unit 202 performs the subsequent processing depending on the result of the comparison.

If the amount of air measured becomes larger than the threshold value, it is determined that the air opening 14a is being covered, the comparison/determination unit 202 sends a control request, such as one for decreasing the clock frequency of the CPU 110, to a power-mode control unit 205. Furthermore, the comparison/determination unit 202 sends a display request to the display control unit 204. Here, the display request is provided for displaying a warning message that notifies the user of a decrease in cooling capability due to the closed air opening 14a.

On the other hand, if the amount of air measured becomes lower than the threshold and the clock frequency of the CPU 110 has already decreased, the comparison/determination unit 202 sends a control request for setting the clock frequency back to the normal one to the power-mode control unit 205. In addition, if the above warning has been already displayed, the comparison/determination unit 202 sends a control request for terminating the display of warning to the display control unit 204.

The fan control unit 203 controls the rotation of the fan 161 in response to a control request from the comparison/determination unit 202. The display control unit 204 displays a warning message for the closing on the monitor 21 in response to a control request from the comparison/determination unit 202. In addition, display control unit 204 may stop displaying the warning message on the monitor 21 in response to a control request from the comparison/determination unit 202. In FIG. 4, the monitor 21 is omitted from the illustration.

The power-mode control unit 205 controls the clock frequency of the CPU 110 in response to the control request from the comparison/determination unit 202. Among the above functions, for example, the fan controller 160 realize the functions of the comparison/determination unit 202, the fan control unit 203, and the power-mode control unit 205 and the CPU 110 executes a predetermined program to realize the function of the display control unit 204.

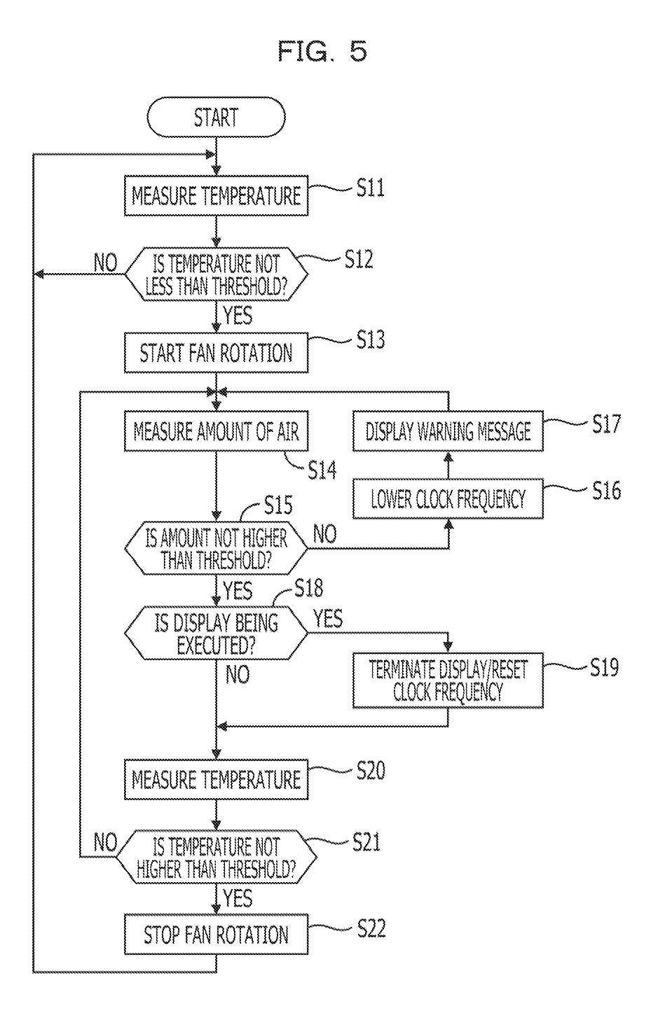

Next, description will be made on a process for determining whether the air opening 14a is being covered and a process for performing predetermined control executed based on the result of the determination, which is carried out in the information processing apparatus 100. FIG. 5 is a flow chart that illustrates the process for determining whether the air opening is being covered, which is executed in the information processing apparatus of the second embodiment.

[Operation S11]

Every time the temperature sensor 162 measures the inner temperature of the information processing apparatus 100, the comparison/determination unit 202 acquires the measured temperature.

[Operation S12]

The comparison/determination unit 202 makes comparison between the measured temperature and the temperature retained by the threshold-retaining unit 201. In the subsequent procedure, if the result of the comparison indicates that the measured temperature is lower than the threshold, or the measured temperature is not equal to or higher than the threshold, the process returns the operation S11. If the measured temperature is not less than the threshold, then the process proceeds to operation S13.

[Operation S13]

The comparison/determination unit 202 requests the fan control unit 203 to rotate the fan 161. This procedure starts the rotation of the fan 161 to exhaust air from the inside of the information processing apparatus 100. At this time, furthermore, the number of rotations of the fan 161 may be controlled based on the measured temperature.

[Operation S14]

Every time the amount of air, which flows from the fan 161, introduced into the air ventilation passage 15, and exhausted, is measured by the air amount sensor 163, the comparison/determination unit 202 acquires the information that represents the measured amount of air.

[Operation S15]

The comparison/determination unit 202 makes comparison between the measured amount of air and the threshold amount of air retained by the threshold-retaining unit 201. If the result of the comparison indicates that the measured amount of air is not more than the threshold, then the process proceeds to operation S18. If the measured amount of air is higher than the threshold, or the measured amount of air is not equal to or less than the threshold, then the process proceeds to operation S16.

[Operation S16]

The comparison/determination unit 202 sends a control request, such as one for decreasing the clock frequency of the CPU 110, to a power-mode control unit 205. This processing lowers the clock frequency of the CPU 110. Thus, the generation of heat from the CPU 110 may be substantially suppressed.

[Operation S17]

Furthermore, the comparison/determination unit 202 sends a display request to the display control unit 204. Here, the display request is provided for displaying a warning message that notifies the user of a decrease in cooling capability due to the fact that the air opening 14a is being covered. This procedure displays the warning message on the monitor 21 to notify the user of the fact that the air opening 14a is being covered. Alternatively, for example, the warning may be performed by sounding an alarm simultaneously with the display of the warning message.

In the loop of operations S14 to S17, while the measured amount of air is larger than the threshold in operation S15, the state of decreased clock frequency can be retained while the warning message is being displayed.

[Operation S18]

The comparison/determination unit 202 determines whether the warning of a decrease in capability is displayed. If the display of the warning is performed in the operation S17, the process proceeds to operation S19. If there is no display of the warning, then the process proceeds to operation S20.

[Operation S19]

The comparison/determination unit 202 sends a request for terminating the display of the warning in operation S17 to the display control unit 204. In addition, the comparison/determination unit 202 sends a control request to the power-mode control unit 205. Here, the control unit may be one for bringing the clock frequency of the CPU 110, which has been decreased in operation S16, back to the original clock frequency. Therefore, this procedure allows the monitor 21 to terminate the display of the warning and brings the clock frequency of the CPU 110 back to the original clock frequency.

[Operation S20]

The comparison/determination unit 202 acquires again the inner temperature of the information processing apparatus 100 measured by the temperature sensor 162.

[Operation S21]

The comparison/determination unit 202 makes comparison between the measured temperature and the temperature retained by the threshold-retaining unit 201. In the subsequent procedure, if the result of the comparison indicates that the measured temperature is higher than the threshold (e.g., the measured temperature is not equal to or lower than the threshold), the process returns to the operation S14. If the measured temperature is not higher than the threshold, then the process proceeds to operation S22.

[Operation S22]

The comparison/determination unit 202 sends a control request, such as one for stopping the rotation of the fan 161, to a power-mode control unit 203. This procedure stops the rotation of the fan 161.

Alternatively, the user may set operation S18 to be not performed. In this case, in operation S19, only a request which terminates the display is transmitted to the display control unit 204.

Next, the operation of the information processing apparatus 100 will be described in detail. First, the case where the air opening 14a is not covered will be described (see FIG. 3). If the inner temperature of the information processing apparatus 100 increases to start the rotation of the fan 161 (operations S11 to S13), then part of air blowing from the fan 161 flows into the air ventilation passage 15 through the branching opening 16b of the air ventilation passage 14.

The comparison/determination unit 202 acquires the amount of air flowing into the air ventilation passage 15, which is measured by the air amount sensor 163 (operation S14), and then makes comparison between the amount of air measured and the threshold amount of air (operation S15). Since the comparison results in the fact that the amount of air measured is lower than the threshold, the comparison/determination unit 202 determines that the exhaust port 14a is not covered.

After the determination, the comparison/determination unit 202 acquires again the temperature measured by the temperature sensor 162 (operation S20) and makes a comparison between the measured temperature and the threshold temperature (operation S21). As long as the measured temperature is higher than the threshold, the exhaust is performed using the fan 161. If the measured temperature becomes lower than the threshold, the comparison/determination unit 202 sends a control request, such as one for stopping the flow of air from the fan 161, to the fan control unit 203 (operation S22) to stop the flow of air from the fan 161.

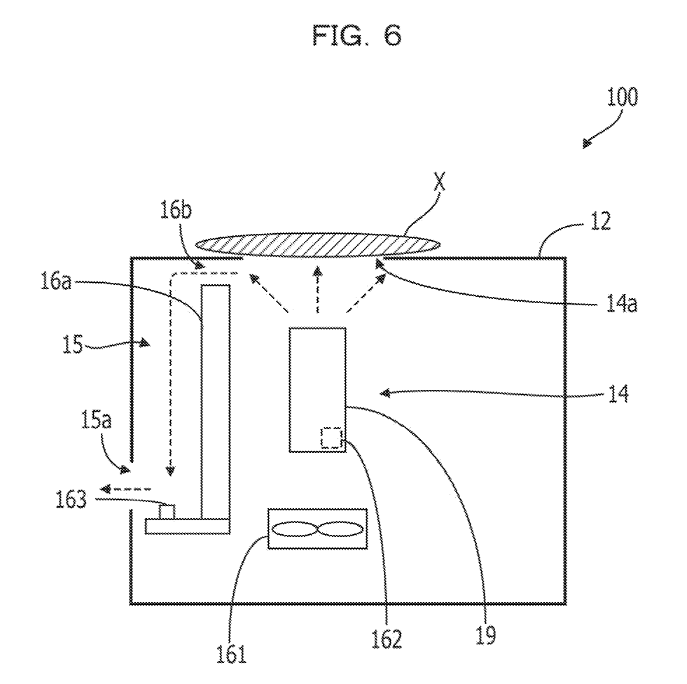

After that, if the inner temperature of the information processing apparatus 100 increases, the above processing is performed. Next, the case where the air opening 14a is being covered will be described. FIG. 6 is a diagram illustrating the state when the air opening of the information processing apparatus of FIG. 3 is being covered;

Like the above description, if the inner temperature of the information processing apparatus 100 increases, the fan 161 starts to rotate (operations S11 to S13). The flow of air from the fan 161 allows the heated air to flow into the air ventilation passage 14. In this case, however, the heated air may not be exhausted sufficiently from the air opening 14a because the air opening 14a is being covered with the covering member X. Thus, most of the air prevented from being discharged from the air opening 14a is branched from the branching opening 16b and then flows into the air ventilation passage 15.

The comparison/determination unit 202 acquires the amount of air measured by the air amount sensor 163 (operation S14) and makes a comparison between the measured amount of air and the threshold amount of air (operation S15). Since the comparison results in the fact that the amount of air measured is higher than the threshold, the comparison/determination unit 202 determines that the exhaust port 14a is being covered.

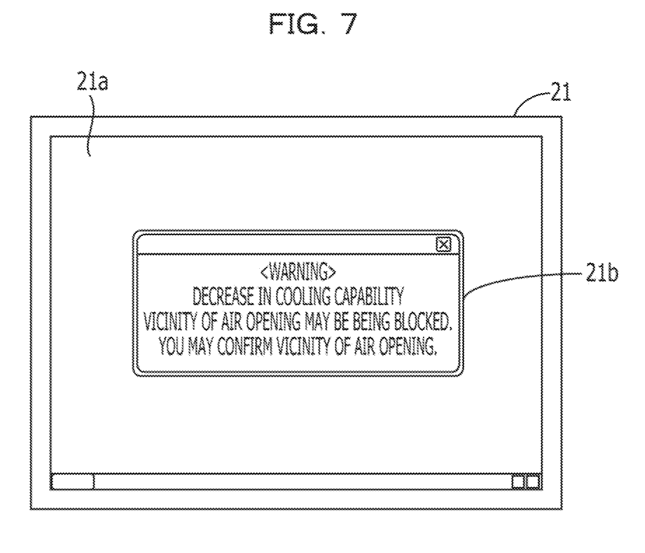

The comparison/determination unit 202 sends a request for decreasing the clock frequency of the CPU 110 to a power-mode control unit 205. As a result, the clock frequency of the CPU 110 decreases (Operation S16). In addition, the comparison/determination unit 202 sends a display request, such as one for displaying a warning of a decrease in cooling capability due to the fact that the air opening 14a is being covered, to the display control unit 204 (operation S17). Then, the monitor 21 displays a warning message, such as one shown in FIG. 7.

FIG. 7 is a diagram illustrating an example of the warning message displayed when the air opening is being covered. The display screen 21a of the monitor 21 shown in FIG. 7 displays a window 21b that warns the user of a decrease in cooling capability due to the fact that the air opening 14a is being covered. If the user visually recognizes the warning, the user is urged to confirm the state of the air opening 14a. If the user confirms the state of the air opening 14a based on the warning message and then removes the covering member X, then the user opens the air opening 14a and restart the exhaust of air from the air opening 14a.

Subsequently, the comparison/determination unit 202 acquires the amount of air flowing into the air ventilation passage 15 measured by the air amount sensor 163 (operation S14) and then makes a comparison between the amount of air measured and the threshold amount of air (operation S15).

Since the air opening 14a has been opened, the result of the comparison shows that the amount of air measured becomes less than the threshold. As a result, the comparison/determination unit 202 determines that the air opening 14a is not covered. Furthermore, the comparison/determination unit 202 sends a request, such as one for brining the clock frequency of the CPU 110 back to the original clock frequency, to the power-mode control unit 205, while sending a display request, such as one for terminating the display of the warning message on the monitor 21 to the display control unit 204 (operation S19).

Subsequently, substantially the same procedures as those of the case where the air opening 14a is not covered are performed. That is, while the measured temperature is higher than the threshold, the exhaust is performed using the fan 161. If the measured temperature becomes lower than the threshold, the comparison/determination unit 202 sends a control request, such as one for stopping the flow of air from the fan 161, to the fan control unit 203 (operation S22) to stop the flow of air from the fan 161.

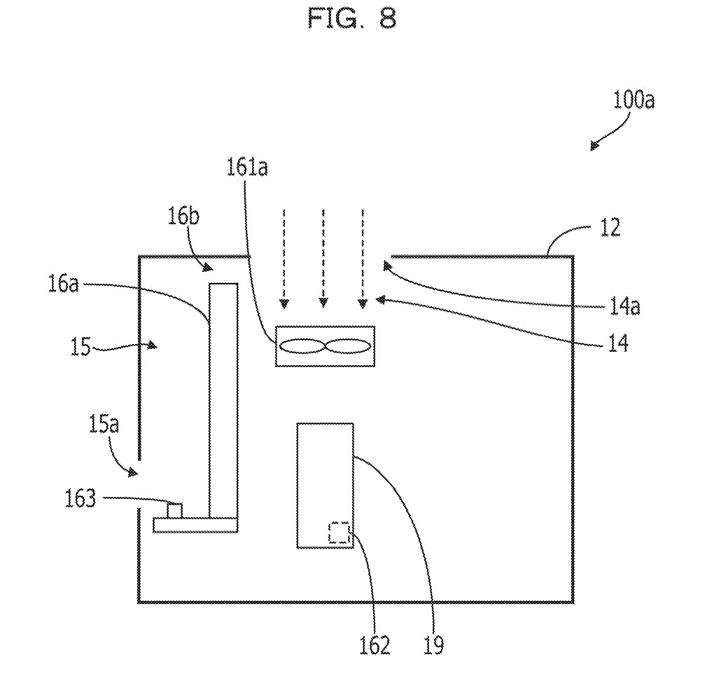

In addition, the determination of covering in the second embodiment may be not only applied to the exhaust of air using the fan 161 but also applied to the intake of air. FIG. 8 is a diagram illustrating a modified example of the second embodiment.

In the information processing apparatus 100a shown in FIG. 8, an air-intake fan 161a is arranged near the air opening 14a. The rotation of the fan 161a allows the external air to flow into the information processing apparatus 100a through the air opening 14a. As a result, the inside of the information processing apparatus 100a can be cooled. Here, other structural components of the information processing apparatus 100a are substantially the same as those of the information processing apparatus 100.

The action of the information processing apparatus 100a at the time of air intake will be described in the context of the flow chart shown in FIG. 5. First, the case where the air opening 14a is not covered will be described (see FIG. 8).

If the inner temperature of the information processing apparatus 100a increases to start the rotation of the fan 161a (operations S11 to S13), then the fan 161a allows the air introduced from the outside through the air opening 14a to flow into the air ventilation passage 14. In addition, the inlet air from the air opening 15a flows into the air ventilation passage 15 and then flows into the air ventilation passage 14 through the branching opening 16b. Furthermore, since the air opening 14a is not covered, the amount of air introduced from the air opening 15a is less than the amount of air introduced from the air opening 14a.

The comparison/determination unit 202 acquires the amount of air flowing into the air ventilation passage 15, which is measured by the air amount sensor 163 (operation S14), and then makes comparison between the amount of air measured and the threshold amount of air (operation S15). Since the comparison results in the fact that the amount of air measured is lower than the threshold, the comparison/determination unit 202 determines that the exhaust port 14a is not covered.

In the subsequent procedures, just as in the case of the exhaust, the intake of air is performed using the fan 161a as long as the measured temperature is higher than the threshold. If the measured temperature becomes lower than the threshold, the comparison/determination unit 202 sends a control request, such as one for stopping the flow of air from the fan 161a, to the fan control unit 203 (operation S22) to stop the flow of air from the fan 161a.

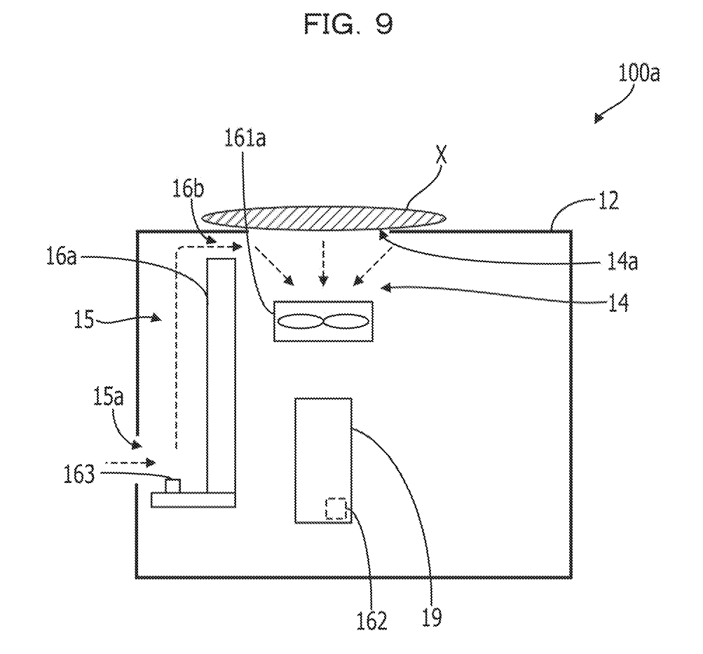

In contrast, the case where the air opening 14a is being covered will be described. FIG. 9 is a diagram illustrating the state when the air opening of the information processing apparatus of FIG. 8 is being covered. Like the above description, if the inner temperature of the information processing apparatus 100a increases, the fan 161a starts to rotate (operations S11 to S13).

The rotation of the fan 161a starts to introduce air into the information processing apparatus 100a. In this case, however, the external air may not be introduced sufficiently from the air opening 14a because the air opening 14a is being covered with the covering member X. Therefore, an increase in amount of air introduced from the air opening 15a occurs. The air from the air opening 15a flows into the air ventilation passage 15 and then flows into the air ventilation passage 14 through the branching opening 16b.

The comparison/determination unit 202 acquires the amount of air measured by the air amount sensor 164 (operation S14) and makes comparison between the measured amount of air and the threshold amount of air (operation S15). Since the comparison results in the fact that the amount of air measured is higher than the threshold, the comparison/determination unit 202 determines that the exhaust port 14a is being covered.

In the subsequent procedures, just as in the case of the exhaust, the clock frequency of the CPU 110 falls (operation S16) and a warning about a decrease in cooling capability due to the shielding is then displayed (operation S17). If the user removes the covering member X from the air opening 14a, the air opening 14a is opened. Since the inlet of air starts again to allow the measured temperature to be lower than the threshold. Subsequently, the comparison/determination unit 202 sends a control request, such as one for stopping the rotation of the fan 161a, to the fan control unit 203 (operation S22) to stop the flow of air from the fan 161a.

Therefore, each of these information processing apparatuses 100 and 100a includes the air ventilation passage 15, which is branched from the mid-flow of the air ventilation passage 14 and communicates with the air opening 15a and the air amount sensor 163 on the air ventilation passage 15. Furthermore, each of the information processing apparatuses 100 and 100a is designed to determine whether the air opening 14a is being covered depending on the amount of air measured by the air amount sensor 163. In addition, depending on the determination, the clock frequency of the CPU 110 is decreased and a decrease in cooling capability due to the closing of the air opening 14a is warned.

Therefore, the state that the air opening 14a is being covered may be detected before a significant increase in inner temperature of each of the information processing apparatuses 100 and 100a. Thus, it is possible to take measures, such as a warning to the user and a decrease in clock frequency, to avoid risks. In addition, generation of heat from the CPU 110 may be prevented. Thus, even if the removal of the covering member X takes much time, an increase in temperature of the information processing apparatus 100 may be substantially prevented or delayed. Therefore the user can promptly address an increase in temperature and prevent each of the information processing apparatuses 100 and 100a from malfunction and failure.

### Third Embodiment

A third embodiment will be described with respect to the case where an additional open/close unit is mounted on the air opening 15a of the information processing apparatus 100 of the second embodiment and the open/close unit is shifted depending on the shield of the air opening 14a.

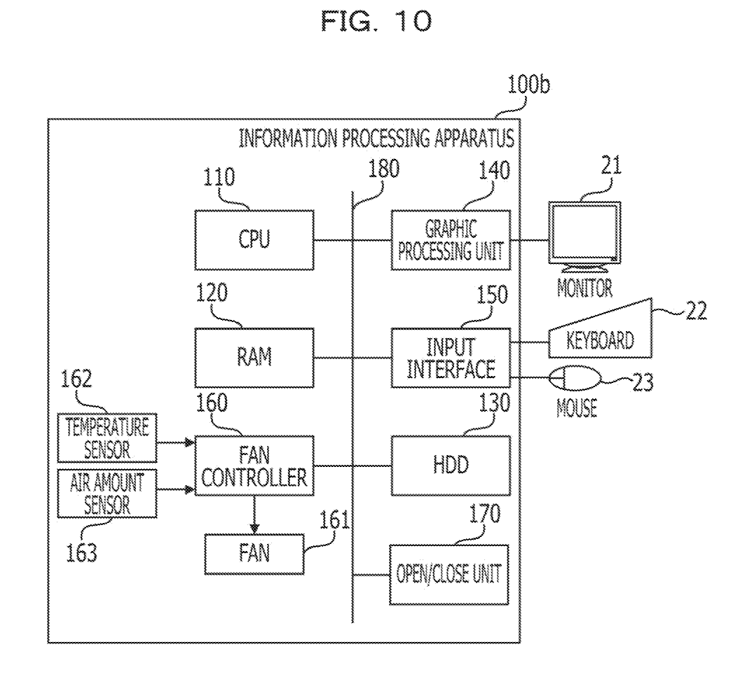

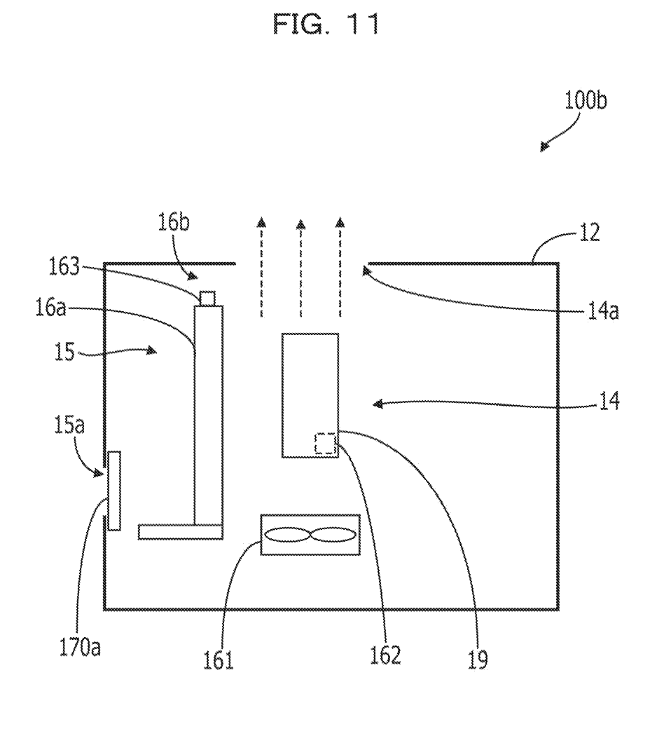

FIG. 10 is a diagram illustrating an example hardware configuration of an information processing apparatus according to the third embodiment. In addition, FIG. 11 is a diagram illustrating an example mechanism of exhausting air from the information processing apparatus according the third embodiment. For instance, the information processing apparatus 100b is realized as a computer as shown in FIG. 2. The computer includes a CPU 110, a RAM 120, a HDD 130, a graphic processing unit 140, an input interface 150, and a fan controller 160. The information processing apparatus 100b further include an open/close unit 170. These structural components are connected to one another through a bus 180 and arranged on their respective predetermined positions (not shown) in the housing 12 as shown in FIG. 11. In addition, a fan 161, a temperature sensor 162, and an air amount sensor 163 are connected to the fan controller 160 and arranged at their predetermined positions in the housing 12 as shown in FIG. 3, respectively.

As shown in FIG. 11, the open/close unit 170 includes a shutter 170a which is openably mounted on the air opening 15a of the housing 12 and an open/close mechanism (not shown) which is able to open and close the shutter 170a. As shown in FIG. 11, shutter 170a is usually held in the state where the air opening 15a is being closed.

In the information processing apparatus 100b, furthermore, the air amount sensor 163 may be preferably arranged near the branching opening 16b of the air ventilation passage 15. This is because of allowing the information processing apparatus 100b to detect a change in amount of air flowing into the air ventilation passage 15 in a short time when the air opening 14a is being covered.

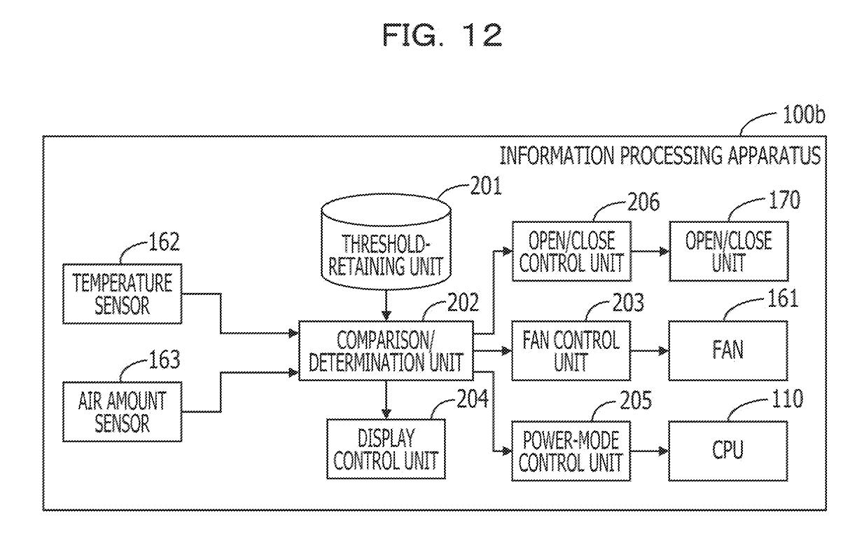

Next, the control function of the information processing apparatus 100b will be described. FIG. 12 is a block diagram illustrating the functions of the information processing apparatus according to the third embodiment. The information processing apparatus 100b determines whether the air opening 14a is being covered and executes predetermined processing depending on the result of the determination. To execute the processing, the information processing apparatus 100b further includes an open/close control unit 206 as well as a threshold-retaining unit 201, a comparison/determination unit 202, a fan control unit 203, a display control unit 204, and a power mode control unit 205.

If it is determined that the air opening 14a is being covered, then the comparison/determination unit 202 sends a request of opening the shutter 170a of the air opening 15a to the open/close control unit 206 of the shutter 170a. If it is determined that the air opening 14a is not covered, then the comparison/determination unit 202 sends a request for closing the shutter 170a to the open/close control unit 206 of the shutter 170a when the air opening 15a is being opened.

The open/close control unit 206 moves the shutter 170a based on the open request from the open/close control unit 206 to open the air opening 15a. In addition, the open/close control unit 206 moves the shutter 170a based on the close request from the comparison/determination unit 202 to close the air opening 15a. Here, for example, the function of the open/close control unit 206 can be realized by a fan controller 160.

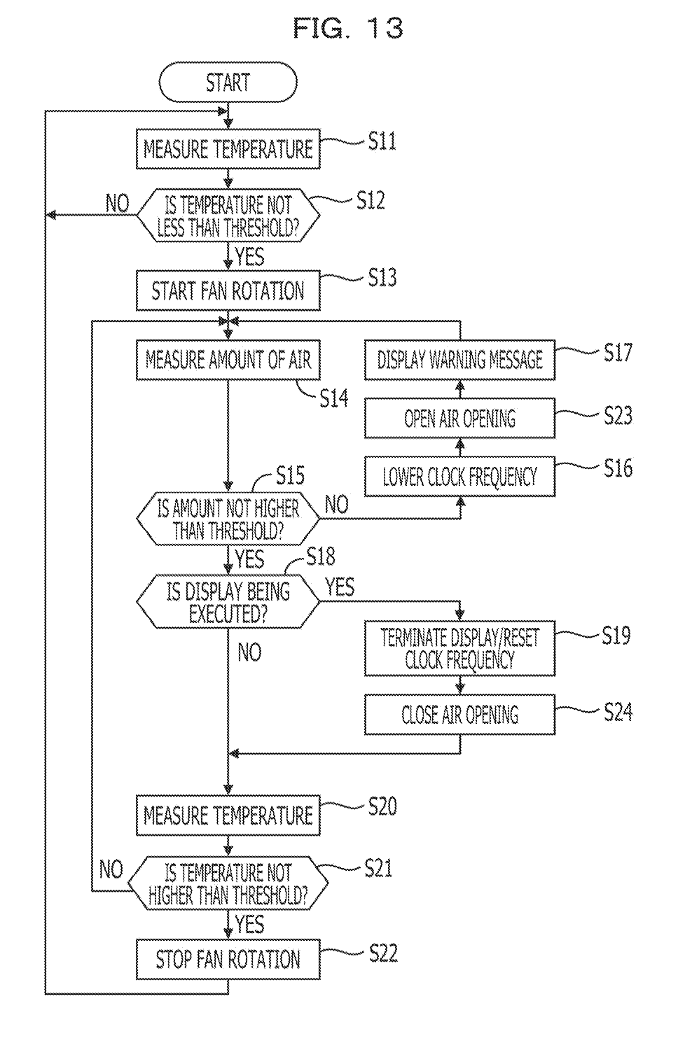

Next, the procedure of determining whether the air opening 14a is being covered and the procedure of a predetermined control process executed based on the result of the determination, which is carried out in the information processing apparatus 100b, will be described. FIG. 13 is a flow chart illustrating a process for determining whether closing of an air opening is performed in the information processing apparatus according to the third embodiment.

Furthermore, in the flow chart shown in FIG. 13, the same operation numbers as those of the flow chart shown in FIG. 5 refer the like procedures. In other words, operations S1 to S22 perform substantially the same procedures as those shown in FIG. 5. Operations S23 and S24, which are only found in the flow chart shown in FIG. 13, will be described below.

[Operation S23]

If the result of the comparison in operation S15 shows that the measured amount of air is more than the threshold, the comparison/determination unit 202 sends a request of opening the shutter 170a to the open/close control unit 206 after lowering the clock frequency of the CPU 110 in operation S16. In this process, the shatter 170a is moved by the open/close control unit 206 to open the air opening 15a.

In the loop of operations S14 to S17 and S23, operation S15 continuously displays a warning, keeps the clock frequency low, and retains the shutter 170a in an opened state as long as the amount of air measured is determined higher than the threshold.

Under such a state, if the amount of air measured becomes not more than the threshold (operations S14 and S15), the warning is ended when the warning has been displayed in operation S17 and the clock frequency of the CPU 110 is then returned to the original state (operation S19).

[Operation S24]

The comparison/determination unit 202 sends a request for closing the shutter 170a to the open/close control unit 206. In this process, the shutter 170a is moved by the open/close control unit 206 to open the air opening 15a.

In the subsequent procedures, just as in the case of the exhaust, the exhaust of air is performed using the fan 161a as long as the measured temperature is higher than the threshold. If the measured temperature becomes lower than the threshold, the comparison/determination unit 202 sends a control request, such as one for stopping the flow of air from the fan 161a, to the fan control unit 203 (operation S22) to stop the flow of air from the fan 161a.

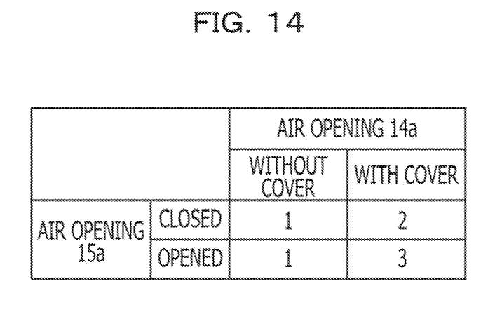

Next, the operation of the information processing apparatus 100b will be described in detail. FIG. 14 is a table illustrating the relation between the amounts of air flow of the respective air ventilation passages of the information processing apparatus according to the third embodiment. FIG. 14 illustrates three different levels of the amount of air as a range of amount of air measured by the air amount sensor 163. In FIG. 14, a range which is equal to or less than the amount of air retained by the threshold-retaining unit 201 corresponds to an air amount level of 1 (one).

First, the case where the air opening 14a is not covered will be described (see FIG. 11). If the inner temperature of the information processing apparatus 100b increases to start the rotation of the fan 161 (operations S11 to S13), then much of air blowing from the fan 161 flows into the air ventilation passage 14 and is then exhausted from the air opening 14a. In addition, part of the air blowing from the fan 161 flows into the air ventilation passage 15 through the branching opening 16 of the air ventilation passage 14.

The comparison/determination unit 202 acquires the amount of air flowing into the air ventilation passage 15, which is measured by the air amount sensor 163 (operation S14), and then makes comparison between the amount of air measured and the threshold amount of air (operation S15). The amount of air at this time is within the range of air amount level 1 and the amount of air measured is not more than the threshold. Thus, the comparison/determination unit 202 is determined that the air opening 14a is not covered.

After the determination, the comparison/determination unit 202 acquires again the temperature measured by the temperature sensor 162 (operation S20) and makes comparison between the measured temperature and the threshold temperature (operation S21). The exhaust is performed using the fan 161 as long as the measured temperature is higher than the threshold. If the measured temperature becomes lower than the threshold, the comparison/determination unit 202 sends a control request, such as one for stopping the flow of air from the fan 161, to the fan control unit 203 to stop the flow of air from the fan 161 (operation S22).

After that, if the inner temperature of the information processing apparatus 100b increases, the above processing is performed. Next, the case where the air opening 14a is being covered will be described.

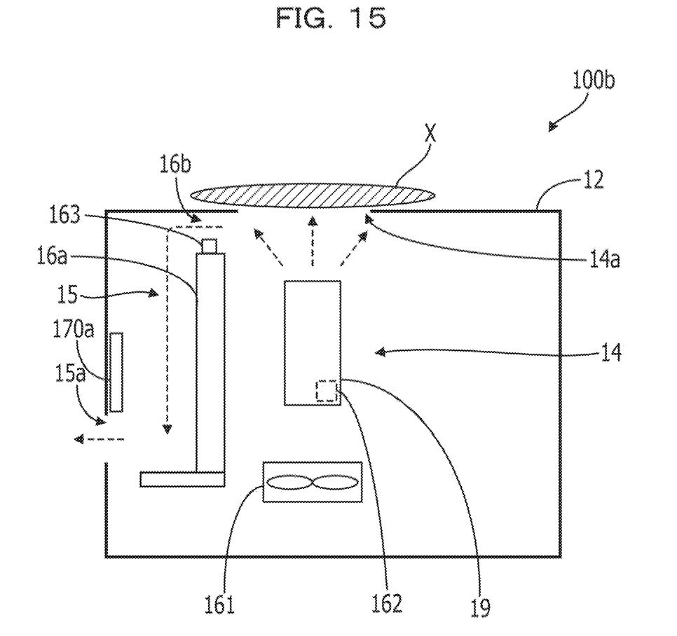

FIG. 15 is a diagram illustrating the state when the air opening of the information processing apparatus of FIG. 11 is being covered. Like the above description, if the inner temperature of the information processing apparatus 100b increases, the fan 161 starts to rotate (operations S11 to S13).

The flow of air from the fan 161 allows the heated air to flow into the air ventilation passage 14. In this case, however, the heated air may not be exhausted sufficiently from the air opening 14a because the air opening 14a is being covered with the covering member X. Thus, most of the air prevented from being discharged from the air opening 14a is branched from the branching opening 16b and then flows into the air ventilation passage 15.

The comparison/determination unit 202 acquires the amount of air measured by the air amount sensor 163 (operation S14) and makes a comparison between the measured amount of air and the threshold amount of air (operation S15). The amount of air at this time is within the range of air amount level 2. Since the comparison results in the fact that the amount of air measured is higher than the threshold, the comparison/determination unit 202 determines that the exhaust port 14a is being covered.

First, the comparison/determination unit 202 sends a request for decreasing the clock frequency of the CPU 110 to a power-mode control unit 205. As a result, the clock frequency of the CPU 110 decreases (operation S16).

In addition, if the comparison/determination unit 202 performs such a determination, it sends a request for opening the air opening 15a to the open/close control unit 206 at first. Then the shutter 170a is moved to open the air opening 15a (operation S23). At this time, for example, the amount of air measured by the air amount sensor 163 may be within the range of air amount level 3 which is higher than air amount level 2.

Furthermore, the comparison/determination unit 202 sends a display request, such as one for displaying a warning of a decrease in cooling capability due to the fact that the air opening 14a is being covered, to the display control unit 204. Then, the monitor 21 displays a warning message, such as one shown in FIG. 7 (operation S17).

If the user confirms the state of the air opening 14a based on such a warning message and removes the covering member X, then the user opens the air opening 14a and restart the exhaust of air from the air opening 14a. Subsequently, the comparison/determination unit 202 acquires the amount of air flowing into the air ventilation passage 15 measured by the air amount sensor 163 (operation S14) and then makes comparison between the amount of air measured and the threshold amount of air (operation S15).

Since the air opening 14a is being opened, the amount of air in the air ventilation passage 15 falls within the range of air amount level 1. Thus, the amount of air measured becomes not more than the threshold. As a result, the comparison/determination unit 202 determines that the air opening 14a is not covered.

Furthermore, the comparison/determination unit 202 sends a request, such as one for brining the clock frequency of the CPU 110 back to the original clock frequency, to the power-mode control unit 205, while sending a display request for terminating the display of the warning message on the monitor 21 to the display control unit 204 (operation S19).

Subsequently, the comparison/determination unit 202 sends a request for closing the air opening 15a to the open/close control unit 206. Then, the shutter 170a is moved to close the air opening 15a (operation S24). In the subsequent procedures, substantially the same procedures as those of the case where the air opening 14a is not covered are performed. That is, while the measured temperature is higher than the threshold, the exhaust is performed using the fan 161. If the measured temperature becomes lower than the threshold, the comparison/determination unit 202 sends a control request, such as one for stopping the flow of air from the fan 161, to the fan control unit 203 (operation S22) to stop the flow of air from the fan 161.

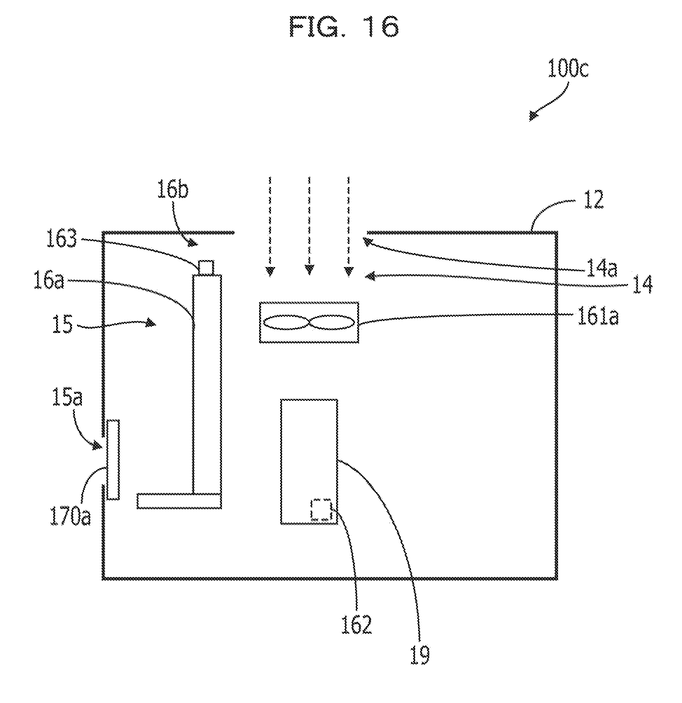

In addition, like the third embodiment, the determination of closing in the second embodiment may be not only applied to the exhaust of air using the fan 161 but also applied to the intake of air. FIG. 16 is a diagram illustrating a modified example of the third embodiment.

As shown in FIG. 16, the information processing apparatus 100c is designed so that the air-intake fan 161a is arranged near the air opening 14a in the information processing apparatus 10b. The rotation of the fan 161a allows the external air to flow into the information processing apparatus 100c through the air opening 14a. As a result, the inside of the information processing apparatus 100a may be cooled. Here, other structural components of the information processing apparatus 100c are substantially the same as those of the information processing apparatus 100b.

The action of the information processing apparatus 100c at the time of air intake will be described in the context of the flow chart shown in FIG. 13. First, the case where the air opening 14a is not covered will be described (see FIG. 16).

If the inner temperature of the information processing apparatus 100c increases to start the rotation of the fan 161a (operations S11 to S13), then the fan 161a allows the air introduced from the outside through the air opening 14a to flow into the air ventilation passage 14. In addition, the inlet air from the air opening 15a flows into the air ventilation passage 15 and then flows into the air ventilation passage 14 through the branching opening 16b. Furthermore, since the air opening 15a is being covered by the shutter 170a, the amount of air introduced from the air opening 15a is less than the amount of air introduced from the air opening 14a.

The comparison/determination unit 202 acquires the amount of air flowing into the air ventilation passage 15, which is measured by the air amount sensor 163 (operation S14), and then makes comparison between the amount of air measured and the threshold amount of air (operation S15). Since the comparison results in the fact that the amount of air measured is lower than the threshold, the comparison/determination unit 202 determines that the exhaust port 14a is not covered.

In the subsequent procedures, just as in the case of the exhaust, the intake of air is performed using the fan 161a as long as the measured temperature is higher than the threshold. If the measured temperature becomes lower than the threshold, the comparison/determination unit 202 sends a control request, such as one for stopping the flow of air from the fan 161a, to the fan control unit 203 (operation S22) to stop the flow of air from the fan 161a.

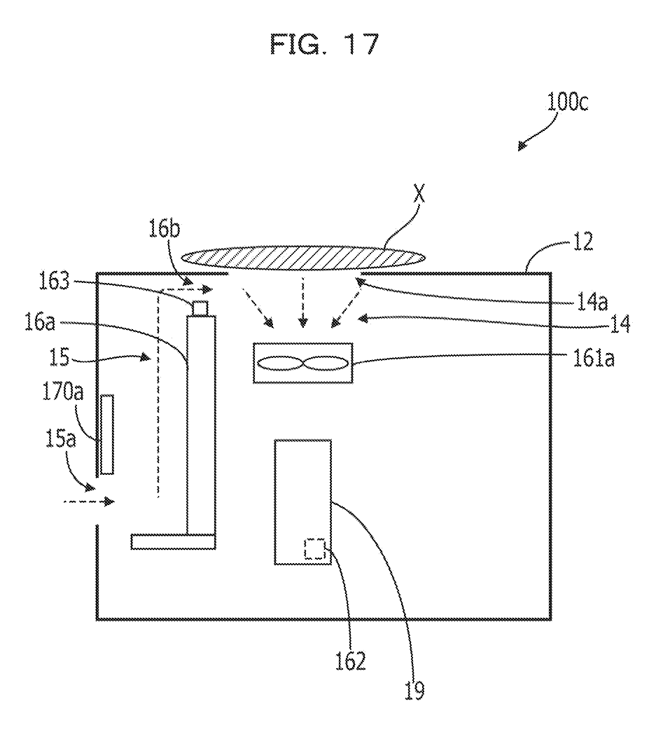

In contrast, the case where the air opening 14a is being covered will be described. FIG. 17 is a diagram illustrating the state when the air opening of the information processing apparatus of FIG. 16 is being covered. Like the above description, if the inner temperature of the information processing apparatus 100c increases, the fan 161a starts to rotate (operations S11 to S13).

The rotation of the fan 161a starts to introduce air into the information processing apparatus 100a. In this case, however, the external air may not be introduced sufficiently from the air opening 14a because the air opening 14a is being covered with the covering member X. Therefore, the air in the air ventilation passage 15 flows into the air ventilation passage 14 from the branching opening 16b.

The comparison/determination unit 202 acquires the amount of air measured by the air amount sensor 163 (operation S14) and makes a comparison between the measured amount of air and the threshold amount of air (operation S15). Since the comparison results in the fact that the amount of air measured is higher than the threshold, the comparison/determination unit 202 determines that the exhaust port 14a is being covered.

In the subsequent procedures, just as in the case of the exhaust, the clock frequency of the CPU 110 falls (operation S16), the shutter 170a is moved to open the air opening 15a (operation S23), and a warning about a decrease in cooling capability due to the fact that the air opening 15a is being covered is then displayed (operation S17). If the user removes the covering member X from the air opening 14a, the air opening 14a is opened. Since the inlet of air starts again to allow the measured temperature to be lower than the threshold. Furthermore, the comparison/determination unit 202 terminates the display of warning (operation S19). Then, the shutter 170a is moved to cross the air opening 15a (operation S24). The comparison/determination unit 202 sends a control request, such as one for stopping the rotation of the fan 161a, to the fan control unit 203 to stop the flow of air from the fan 161a (operation S22).

Therefore, each of these information processing apparatuses 100b and 100c includes the air ventilation passage 15, which is branched from the mid-flow of the air ventilation passage 14 and communicates with the air opening 15a and the air amount sensor 163 on the air ventilation passage 15. Furthermore, each of the information processing apparatuses 100b and 100c is designed to determine whether the air opening 14a is being covered depending on the amount of air measured by the air amount sensor 163. In addition, depending on the determination, the clock frequency of the CPU 110 is decreased and a decrease in cooling capability due to the closing of the air opening 14a is warned. Then, the air opening 15a in closed state is opened.

Therefore, before a significant increase in temperature in each of the information processing apparatuses 100b and 100c, the shielding of the air opening 14a may be detected. In addition, generation of heat from the CPU 110 may be prevented. Thus, even if the removal of the covering member X takes much time, an increase in temperature of each of the information processing apparatuses 100b and 100c may be substantially prevented or delayed. Furthermore, foreign substances may be prevented from entering into the air opening 15a at the time other than ventilation. Therefore the user may promptly address an increase in temperature and prevent each of the information processing apparatuses 100b and 100c from malfunction and failure.

The comparison/determination functions and the device control functions of the information processing apparatuses 100, 100a, 100b, and 100c illustrated in the embodiments described above may be realized by computers, respectively, for example. In such cases, programs in which the contents of the procedures of the above functions are provided. Then, the programs may be executed on the computer to realize the above processing functions on the computer. The programs that describe the contents of processing may be stored in a recording media which are readable by the computer. Examples of the recording medium readable by the computer include a magnetic recording medium, an optical disc, a magneto-optical recording medium, and a semiconductor memory.

To distribute the programs, for example, transportable recording media, such as optical discs, storing such programs are commercially available. Furthermore, the programs may be stored in the storage device of a server computer in advance and the programs may be then transferred from the server computer to other computers through network.

More specifically, for example, a computer that intends to execute a program stores it in its storage device from the transportable recording medium or from the server computer. Then, the computer reads the program from its storage device and then executes processing according to the program. Alternatively, the computer may directly read the program out of the transportable recording medium. In addition, the computer may execute plural kinds of processing according to the respective programs successively transferred and received from the server computer.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An information processing apparatus having a fan that releases air from the inside of a housing, comprising:
a first passage through which air flows from the fan to a first air outlet;
a second passage branched from the mid-flow of the first passage and communicating with a second air outlet;
an air amount meter arranged in the second passage, which measures the amount of air flow from the first passage to the second passage; and
a determining unit that determines whether the first air outlet is covered based on the amount of air measured by the air amount meter.

2. The information processing apparatus according to claim 1, wherein
the determining unit makes a comparison between the amount of air and a predetermined threshold and determines that the first air outlet is covered when the amount of air is higher than the predetermined threshold.

3. The information processing apparatus according to claim 1, further comprising:
a warning unit that warns that the first air outlet is covered when the determining unit determines that the first air outlet is covered.

4. The information processing apparatus according to claim 1, further comprising:
an open/close unit that opens and closes the second air outlet; and
an open/close control unit that controls the open/close unit so that the second air outlet is changed from a closed state to an opened state when the determining unit determines that the first air outlet is covered.

5. The information processing apparatus according to claim 1, wherein
the air amount meter is mounted in the second passage and is located on a portion of a partition where the second passage is branched from the first passage.

6. The information processing apparatus according to claim 1, further comprising:
a fan control unit that increases the amount of air flowing from the fan when the determining unit determines that the first air outlet is covered.

7. The information processing apparatus according to claim 1, further comprising:
a power-mode control unit that decreases the clock frequency of a control circuit of the information processing apparatus when the determining unit determines that the first air outlet is covered.

8. An information processing apparatus having a fan that introduces air into the inside of a housing, comprising:
a first passage through which air to be introduced from a first air inlet to the fan passes;
a second passage branched from the mid-flow of the first passage and communicating with a second air inlet;
an air amount meter arranged in the second passage, which measures the amount of air introduced from the second air inlet to the second passage which then flows into the first passage; and
a determining unit that determines whether the first air inlet is covered based on the amount of air measured by the air amount meter.
